(19) United States
(12) Patent Application Publication
(10) Pub. No.: US 2009/0167513 A1
(43) Pub. Date: Jul. 2, 2009

(54) Integrated Vehicular Positioning and Communications System

(76) Inventors: Lawrence W. Hill, North Eastham, MA (US); Alexander Herman, Sharon, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/086,161

(22) PCT Filed: Dec. 8, 2006
(86) PCT No.: PCT/US2006/047123

§ 371 Date: Jun. 6, 2008

Related U.S. Application Data
(60) Provisional application No. 60/748,836, filed on Dec. 9, 2005.
(60) Provisional application No. 60/814,812, filed on Jun. 19, 2006.

(51) Int. Cl. B60Q 1/00; H04W 4/04

(52) U.S. Cl. 340/435; 370/328

(57) ABSTRACT

A wireless vehicular positioning and communications system that combines inter-vehicular ranging and a self-organizing TDMA MAC protocol to both achieve more accurate positioning than is possible with GPS positioning and provide a deterministic channel for inter-vehicle communication. The band used for the system is divided into time slots, with each vehicle being able to obtain a time slot autonomously. Within a time slot, there is a ranging signal which occupies the full bandwidth; following the ranging signal, the band is divided into sub-bands. Some of the sub-bands are used to send packets according to the TDMA MAC protocol, and thus provide the deterministic channel; others are used for a non-deterministic channel which may be used for packets following the Internet Protocols. The system also uses mesh networking to permit vehicles to obtain advance warning of abnormal conditions in other vehicles.

### CROSS-REFERENCE TO RELATED APPLICATIONS

This patent application claims priority from the U.S. Provisional Patent Applications
60/748,836, Lawrence A. Hill and Alexander Herman, Integrated communications and navigation system, filed 9 Dec. 2005; and
60/848,812, having the same inventors and title and filed 19 Jun. 2006.

Both applications are assigned to the assignee of the present application; both are further incorporated by reference into the present patent application for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to reliable, low latency wireless data communication between vehicles moving at highway speeds, and to discerning the positions of such vehicles with high accuracy.

2. Description of Related Art

The next major revolution in networking will be automotive networking, also referred to as IVHS (Intelligent Vehicle Highway System). The adaptation of a high speed, broadband data network to moving vehicles is being driven by three entities: governmental agencies, communications and networking companies, and automobile manufacturers.

The Federal and State governments are concerned with safety on the nation's highways. The 42,000 annual fatalities on the roadways are estimated to cost over $200 billion in loss of life, property damage, lost wages, etc. The Federal Government has participated in legislating safety equipment on vehicles such as air bags and antilock brakes. These features have reduced fatalities but the next major push will be systems that shift the focus from mitigating vehicle crashes to avoiding collisions. The Federal Government is seeking to deploy a system that can warn drivers of impending problems in a manner similar to that of the Air Traffic Control (ATC) system. A network of communicating subscribers including vehicles and roadside units can warn drivers to avoid collisions, warn of intersection violations, lane departure, sudden brake applications, slippery roads, etc. Such a network also has obvious value in dealing with major disasters, evacuations, response by Homeland Security Agencies and smaller scale public safety incidents where various responders must coordinate with one another. The FCC has allocated 70 MHz of spectrum at 5.9 GHz to IVHS, as well as spectrum at 4.9 GHz for public safety. Public safety interests clearly overlap the IVHS mission.

Communications networking companies, including telecoms and internet portal providers, see a channel to provide entertainment and advertising to vehicle passengers.

Automobile manufacturers see a method of improving customer care and vehicle reliability through interaction with on-board vehicle systems.

In July 2005, the US department of Transportation issued a document entitled VII Architecture and Functional Requirements which established basic requirements for a system including road-side units (RSE) with connectivity to an IP-based network and to the internet and on-board equipment (OBE) connected to vehicle electronics. The OBEs must communicate reliably with each other, and with the RSEs under both normal and emergency traffic conditions. Further accurate position-location of the moving vehicles relative to the road and to each other is required to tolerances of 20 cm (about 8 inches) to one foot.

Such a system will be of value to emergency first-responders in disaster situations, and for other homeland Security applications. It will also be of value to the military, particularly for command and control of platoons of autonomous robots.

Initial demonstrations with a version of the VII architecture which uses radio links based upon WIFI 802.11a consumer chip sets, stationary wireless cells based on road side units, and GPS for positioning have uncovered the following problems:
1. severe and rapidly changing multipath interference due to reflections from surrounding vehicles and roadside structures moving at a relative velocity of 65 MPH (or more in some countries).
2. Use of GPS for positioning, which in many situations is not sufficiently accurate to support the desired traffic management and collision-avoidance measures. The required accuracy is variously deemed to be in the range of less than one foot to less than 20 cm.
3. road-side access points which remain within range of a given vehicle for only a short time, necessitating complex, error-prone, and bandwidth-inefficient hand-off algorithms.
4. use of CSMA MAC algorithms, which do not deliver a guaranteed upper limit on latency in emergency situations where most or all subscribers must suddenly transmit at about the same time

Standards for an improved system are in the course of development within IEEE 802.11p and IEEE 1609 committees.

Possible avenues of improvement include:

Using COFDM and MIMO methods for data signal structures. These methods are well suited to a situation involving moving transceivers, many metallic objects (automobiles) generating dense multipath. As is well known, COFDM, which included coding across frequency as well as time, can deliver valid data in many situations where errors are not recoverable if just OFDM is used. This is well demonstrated by the European digital television standards DVB-T and DVB-H, which employ such techniques, by the IEEE 802.16e standard, and by the evolving IEEE 802.11n standard. It is important to note however, that since IEEE 802.11n is oriented toward very high data rates over shorter distances than IVHS requires, it mandates an inter-symbol guard time of no more than 800 nanoseconds, which will create potentially fatal inter-symbol interference due to multipath at distances much over 100 meters.

Using a positioning technique which is more accurate than GPS. In GPS, position is calculated using messages received from multiple satellites which are at known positions. Each message includes the time at which it was sent, and the GPS receiver can determine the range to the satellite from the time at which the message arrives in the receiver. Given the ranges and positions, the receiver can use triangulation to determine its position.

Much greater accuracy is, however, possible if the ranging is not done using satellites, but instead within a group of surrounding objects. The improvement in accuracy is particularly good with regard to the distances between the objects. This type of ranging predates GPS. For example, PLARACTA, SEEK BUS, and early JTIDS programs in the US military in the mid-1970s demonstrated cooperative common-grid navigation using time-of arrival (TOA). These systems required that stations with known position exist, to provide an absolute reference, but all the units ranged off each other to provide a common navigation grid. Units reported on a time division multiple access radio bus. Each had one or more assigned time slots, in which it repeatedly reports its own position, velocity vector, status, and tactical situation data. The basic mechanism remains in Link-16, which supports TOA determination today. As implemented in these systems, the scheme does not provide sufficient accuracy for the IVHS application and is at the present time too big and expensive for automotive applications. In addition, it uses a hierarchical, centralized approach to time slot assignment, which is not suitable for the automotive environment.

Using networking techniques which permit the cells of communicating vehicles to move with the vehicles. A technique which permits moving cells is described in RR-Aloha, a Reliable R-ALOHA Broadcast Channel for ad-hoc Inter-vehicle Communication Networks, Borgonovo et al, Politecnio di Milano.) This paper describes a novel Media Access control (MAC) protocol, which is able to guarantee a reliable single-hop broadcast communication in an ad-hoc network environment where the hidden terminals problem exists. This protocol is designed for the inter-vehicle communication architecture based on UTRA-TDD slotted physical channels, but can be easily modified to operate on other standard physical layers. This protocol is self-organizing: any active terminal can autonomously reserve a channel by capturing a slot in the frame. Reliable communication is guaranteed, after access, even in presence of hidden terminals thanks to the information exchanged by the active terminals. The operation of the protocol is completely distributed and also enables the use of channels of different speeds to satisfy Quality of Service of different services.

It is thus an object of the invention to provide improved positioning and communication between groups of moving vehicles.

### BRIEF SUMMARY OF THE INVENTION

In one aspect, the foregoing object is attained by apparatus in a vehicle for determining the vehicle's position relative to a number of other vehicles. Each of the vehicles is associated with a set of time slots in a sequence of the time slots. The apparatus has a physical layer, a media access layer, and an application layer. The physical layer broadcasts packets in the set of slots associated with the vehicle and receives packets in the sets of slots associated with the other vehicles. The media access layer autonomously establishes the association between the vehicle and the set of time slots and provides packets received from the application layer to the physical layer and vice-versa. The application layer provides a packet to the media access layer for broadcast in a time slot of the set. The provided packet contains current position information for the vehicle. The application layer computes the current position information from a number of packets that have been received from the other vehicles. The computation employs the time the received packet was broadcast, the time the received packet was received, and the position information in the received packet from each of the received packets.

In another aspect, the foregoing object is attained by a method of allocating a band of spectrum between ranging and data transfer. The band is divided into time slots and the steps of the method are performed in each time slot. The steps include transmitting a ranging preamble that occupies the band's entire bandwidth during a first portion of the time slot; and transmitting one or more data packets during a second portion of the time slot. Each data packet is transmitted on a discrete sub-band of the spectrum.

In a further aspect, the foregoing object is attained by apparatus in a vehicle for relaying information about another vehicle to a plurality of the other vehicles. Each of the vehicles has an association with a set of time slots in a sequence of the time slots. The apparatus includes a physical layer, a media access layer, and an application layer. The physical layer broadcasts packets in the set of slots associated with the vehicle and receives packets in the sets of slots associated with the other vehicles. The packets include first position and status information for the vehicle associated with the time slot the packet is broadcast in and second position and status information for a vehicle of the plurality of other vehicles. The media access layer provides packets received from the application layer to the physical layer and vice-versa. The application layer selects information to be included in the second position and status information in the next packet to be provided to the media access layer from the first or second position and status information in the packets received from the media access layer.

### BRIEF DESCRIPTION OF THE SEVERAL VIEWS OF THE DRAWINGS

FIG. 1 is an overview of a vehicular positioning and communication system according to the invention;

FIG. 2 shows how the spectrum employed for communication and ranging is allocated among these functions;

FIG. 3 shows the structure of the TDMA packets used in the invention;

FIG. 4 is a block diagram of a transceiver for the communication and ranging system; and

FIG. 5 is a diagram showing how the autonomous MAC structure is used to create moving cells of vehicles.

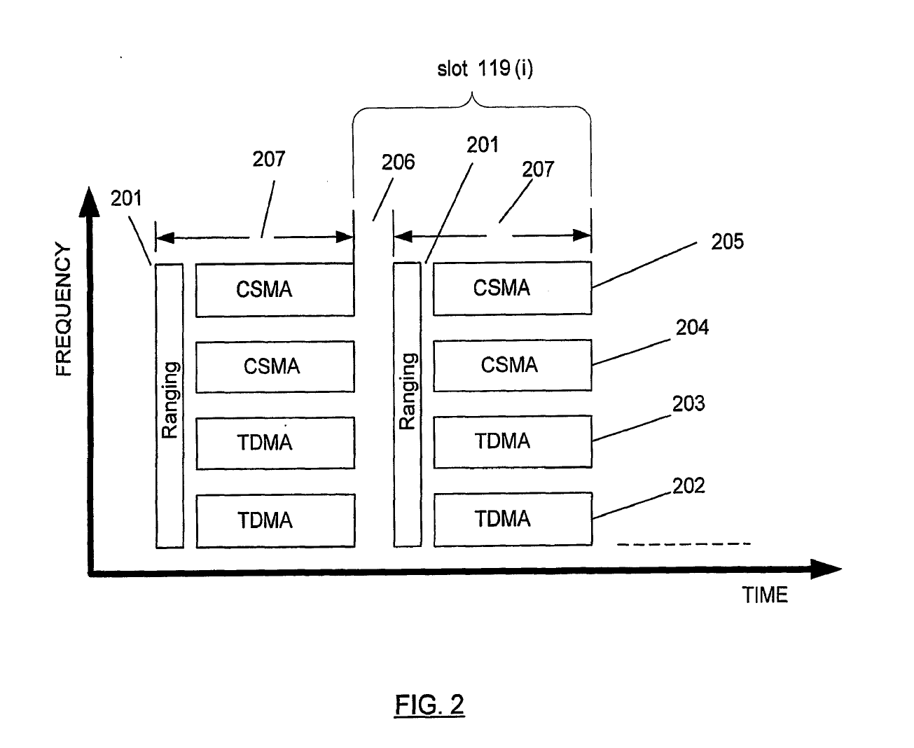

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

Overview

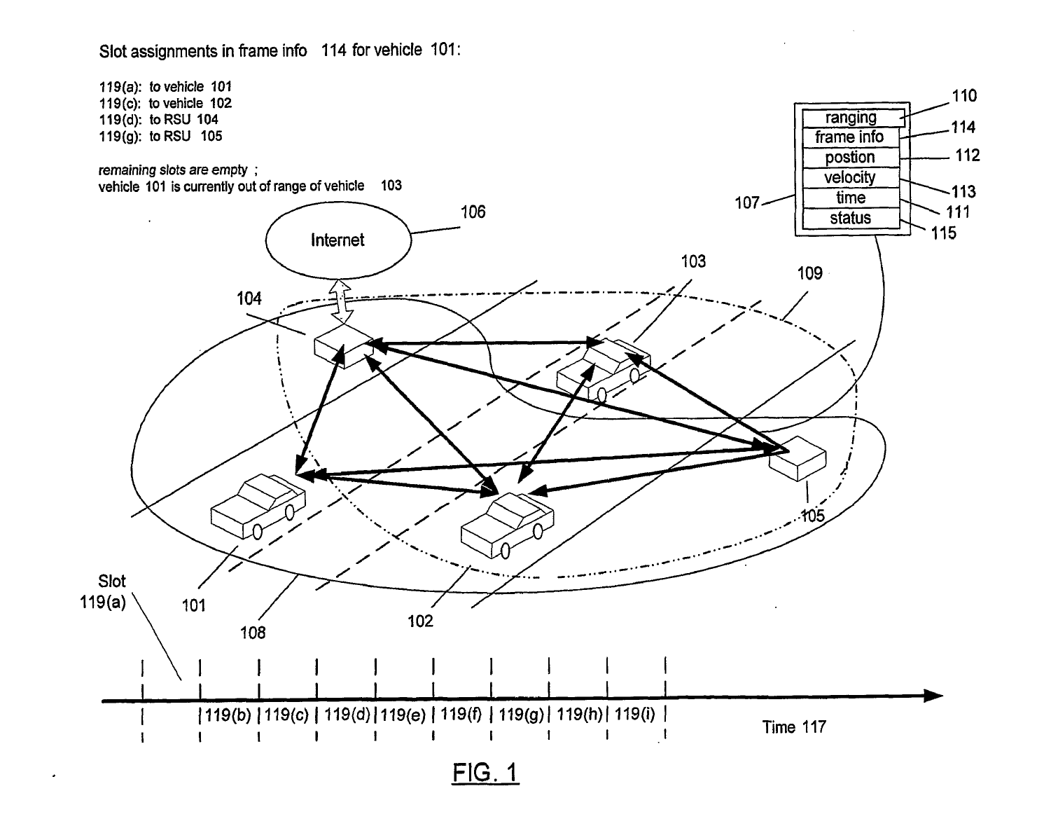

FIG. 1 is a top-level description of the system. Subscribers include vehicles 101, 102, and 103 and roadside units 104 and 105. Each subscriber is associated with a time slot 119 and can broadcast short messages in its time slot using a time division multiple access (TDMA) MAC protocol. Roadside units may connect to the internet (106).

The message broadcast by a subscriber includes a data packet (107) which contains a time-marker for ranging, as well as the subscriber's best estimate of his current position, time, and velocity. The subscribers belong to a changing set of moving cells The members of each cell are those subscribers that are in mutual communication at any point in time. For example, in FIG. 1 the cell seen by subscriber 101 consists of itself and those other subscribers (102, 104, 105) within dotted line 108, whereas the cell seen by subscriber 103 consists of itself and those subscribers within dotted line 109 (102, 104,105). Within each cell, each member is assigned a time slot 119 during which the member broadcasts. When not broadcasting, each member listens to the broadcasts by the other members. During its slot, each member broadcasts a ranging signal 110 and data which indicates the time 111 at which the ranging signal was broadcast, current position 112 and velocity 113 of the member, frame information 114 indicating which slots in the cell are currently assigned to subscribers, and status information 115 for the member.

A subscriber determines its location by receiving corresponding data packets 107 from all units within range, compares received time (measured locally) with transmitted time (measured by the transmitter and included in the message) to estimate propagation delay and hence distance to each subscriber. The subscriber then solves a simultaneous set of equations similar to the GPS equations to determine his position relative to all other subscribers within range. The difference is that he is estimating distance to nearby subscribers, not distant satellites.

In addition to the information related to position location, each packet 107 includes status and situation data 115 pertaining to the transmitting subscriber, such as emergency situations, mechanical failures, traffic congestion, etc.

Different modulation structures are used for the ranging preamble (109) and for the data transfer (107). The ranging preamble (109) is designed for optimal localization in time of the transmission over the shortest path, while rejecting delayed, later-arriving multipath signals. This can either use a time-coded wide band pulse train, or a direct sequence encoded PSK modulation, following radar practice familiar to those skilled in the art in each case.

The data modulation is designed for reliability and multipath immunity, and hence makes used of coded orthogonal frequency division multiplexing (COFDM) and multiple input, multiple output (MIMO) techniques familiar to those skilled in the art.

This system will operate in the 75 MHz frequency band allocated by the FCC for IVHS use at 5.9 GHz, or other bands as appropriate to specific uses, for example the 4.9 GHz public safety band.

The system employs a self-organizing TDMA MAC (Time Division Multiple Access Media Access Control Layer protocol) to guarantee media access for safety-critical applications. In the self-organizing TDMA MAC, frame Information 114 is included in each broadcast packet. This information identifies to all current and potential subscribers which time slots are already occupied by other subscribers as heard by each subscriber individually. With this information a simple set of rules described in the body of this disclosure enables a new subscriber to join the network autonomously. Broadcasts by the new subscriber will not interfere with broadcasts by any other subscribers within range of the new subscriber. Further, it can be shown that such an algorithm can function in a timely manner considering the range to the radio system and the velocity of the vehicle-based subscribers participating in the network.

The following sections address in more detail the ranging and position/location subsystem, the time slot and packet structure, the physical signal structure for ranging and for data transfer, the MAC protocol associated with the system, and the means for forwarding selected data to recipients outside the range of the cell in which such data originates.

Ranging and Positioning

Inter-element ranging and positioning are accomplished as follows. In summary, the system operates like a GPS receiver, except that instead of using satellites, it operates by ranging off all other subscribers in the cell.

Each participant broadcasts a ranging preamble 110, followed by a data packet containing its best estimate of its own position 112 velocity 113 and time 111. It uses the information from the data packets received from its neighbors to deduce distance to the respective transmitters based upon the time stamp in the message (when it was transmitted) and the time at which it received (measured locally) as the time at which the corresponding ranging preamble was detected. This information is then used to refine its own position estimate, by triangulating off all transmitters from which it received a ranging preamble 110 and valid data message. The process iterates continuously at all subscribers, and converges to accurate position estimates for all

The basic GPS equations pertain, whether the transmitting units are satellites or other local subscribers The range from the receiver to any unit i is defined by:

Pᵢ=[(xᵢ−x)²+(yᵢ−y)²)+(zᵢ−z)^{2]}^{1/2}+cdT+Iᵢ+Tᵢ+eᵢ

Where:
Pᵢ range to i^{th} transmitter
xᵢ, yᵢ, zᵢ=coordinates of i^{th} transmitter
x, y, z=coordinates of receiver
c=speed of light
dT=receiver clock offset
Iᵢ=ionospheric effect
Tᵢ=tropospheric refraction error
eᵢ=measurement noise

Iᵢ, Tᵢ, and eᵢ are generally ignored In calculations performed by a receiver. The first two are somewhat ameliorated in GPS by the fact that two different frequencies are employed. Measurement noise is a consequence of the signal-noise (SIN) ratio of the signal;

x, y, z, and dT are then four unknowns in the equation. So, four observations from four different participating units will provide four equations, which allow a solution to the set of equations.

The equations are nonlinear because of the square root in the distance calculation, and in the early days were solved iteratively through a Taylor Series approximation. Closed-form solutions have since been developed which ease the computational burden, however. These solutions have also been extended to include a larger number of observations per position

With more than four subscribers, it is possible to develop, over repeated measurements, an accurate relative position and time vector. To anchor this into geographic latitude longitude altitude and real time, a total of four subscribers are required whose x, y, z, t coordinates are known in an absolute sense. Participation of such subscribers will then “ground” the navigation grid of the moving subscribers to absolute (in addition to relative) values. In the present invention, this is accomplished by a combination of road-side units whose which are fixed to the ground at surveyed locations. A subscriber with a surveyed location always transmits that location in its packet; such a subscriber does not recalculate his position based upon ranging. Alternately, subscribers with GPS receivers use information derived from them both to provide a time reference, and a (relatively imprecise) position reference. In either case, the subscriber may have a map describing the position of the road, and may relate the position determined as described above to the mapped position of the road, in a manner similar to conventional GPS-based in-car navigation systems.

Use of velocity vectors can materially improve the estimation process. If each reporting unit includes in its message not only its present position but its present velocity vector, and whether that vector has changes since the last report, then the receiver knows where the vehicle should be on the nth sample based on its position at the (n−1)th sample. This can produce a material increase in estimate accuracy.

Spectrum Allocation

A key element in the accuracy of the system is the allocation of time and frequency between ranging and data transfer functions in a time slot 119. This is shown in FIG. 2.

For purposes of illustration but with no loss of generality, a system is described which will operate in a 75 MHz band (9) located at 5.9 GHz.

The protocol time slot and spectrum allocation is designed to allow efficient use and coexistence of the three key system features. Each time slot 119 includes:
1. Ranging Preamble (201) which facilitates accurate positioning of fast moving vehicles. Such a preamble is transmitted by each subscriber immediately prior to broadcasting a packet 107 in a TDMA-organized channel (202) in slot 119(i) belonging to the subscriber.
2. Packets 107 broadcast on channel 202 contain information for a wireless data communication system for mission critical (road) applications and data transfer associated with the ranging function. The communication system employs a TDMA MAC which is characterized by the following attributes: (a) self organizing; (b) fully distributed; (c) deterministic; (d) used for inter-vehicle and vehicle to road infrastructure communications; (e) multi megabit per second. One or more ((preferably two) 25 MBPS channels are allocated to this function (202), (203).
3. Packets broadcast on channel 203, which is for a wireless communication system for leisure (non-mission critical) applications, characterized by the following attributes: (a) ubiquitous; (b) multi megabit per second. (c) best-effort class of service rather than deterministic (d) supports TCP/IP formats and applications (204), (205).
4. Guard time 206 separates the end of the data portion of the preceding time slot from the ranging signal in the next time slot.

In summary, The spectrum allocation in a slot 119 has four parts:

1. A ranging preamble which occupies the entire bandwidth (here, 75 MHz) (201).
2. A TDMA channel for mission critical applications such as ranging data. (202). Each vehicle that is currently in the cell belonging to the cell has a guaranteed slot in the TDMA channel. The ranging preamble is the preamble for the TDMA channel. (202), (203)
3. One or more CSMA channels (204, (205) for all other applications. Broadcasts are not made on the CSMA channel during the times occupied by the ranging preamble (201).
4. A guard time (206) between ranging waveforms and the data transmission which is sufficient to avoid overlap given the timing accuracy of the aggregate system.

The accuracy of an RF based system for positioning of fast moving vehicle is directly proportional to the bandwidth used. Therefore, the system design allocates the entire available spectrum (maximizing accuracy) for short periods of time (˜10 microseconds), >1000 times per second for the sole use of the ranging preamble. As a result, 99% of the time the entire spectrum is still available for communication. The wave form used in the ranging preamble is a radar ranging wave form.

The protocol time slot and spectrum allocation is able to synchronize the ranging preamble and the TDMA slotting among plurality of vehicles using available GPS time ticks.

An alternate implementation does not depend upon GPS time ticks. With this approach, the first vehicle to start transmitting in a cell defines the time frame, and other units abide by its framing when they come on line. In the event that two previously separate (non-communicating) cells of vehicles converge and begin to overlap, the cell having fewer members (as defined by its Frame information field 114) will defer to the larger cell; members of the smaller cell will abandon their previous slot and join the larger cell . An algorithm for doing this is described below.

A ubiquitous CSMA link layer protocol is slightly modified (using available GPS time ticks) to allow ‘dead time slots’ which are occupied by the ranging preamble. The ranging preamble thus “steals” 1% of the time available on the CSMA channel, with minimal impact to its expected performance.

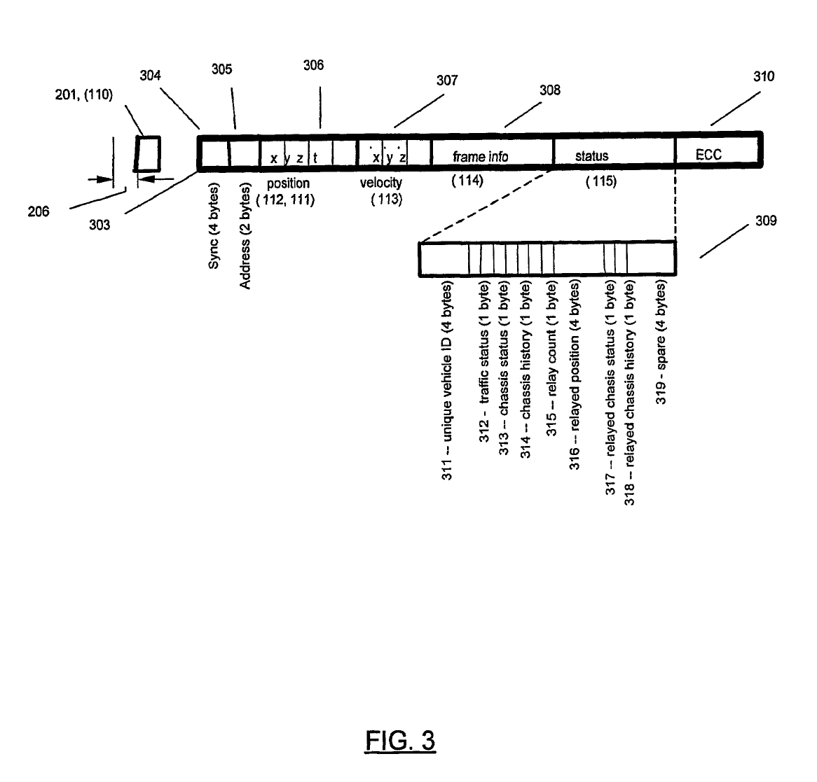

The TDMA packet structure is shown in FIG. 3 and described below. Components of the structure that correspond to components of packet 107 are indicated by reference numbers referring to that packet in parenthesis. Components shown in FIG. 2 have the reference numbers used for them in that Figure.
MAC timeout and packet guard time=10 microseconds (206)
Wide-band ranging waveform (201)=10 microseconds
Data Packet (303), consisting of:
   Sync—4 bytes (304)
   Address (sequential time slot number)—2 bytes (305)
   Position and time of transmission: (x, y, z, t)—8 bytes, 16 bit Floating Point representation (306)
   Velocity—dx/dt,dy/dt,dz/dt,—6 bytes, 16 bit Floating Point representation (307)
   Frame information for autonomous slot assignment, assuming 200 slots per recurring frame and one bit per slot—50 bytes (308)
   Unit status & descriptors, discussed further below,=16 bytes (309)
   Packet error detection code—2 bytes (310)
   Total 88 bytes or 704 information bits per frame

Assuming a ⅓ code, this amounts to 2112 bits per packet 303 or a 105 microseconds transmission time for packet 303 at 20 MBPS raw rate.

If guard time is 20 microseconds, and the ranging waveform duration is 10 microseconds then the total duration of a time slot is 135 microseconds and cycle time for a cell of 200 subscribers is 0.027 seconds. If 100 subscribers consist of cars 30 ft apart on four lanes, a cell is 1.5 miles long and four lanes wide, not counting Road Side Units.

Because of multi-path effects, the appropriate guard time is a trade-off between channel efficiency and desired range/power/sensitivity.

Signal Structure.

Because of the different performance considerations associated with each, different modulation structures are used for the ranging and the data transfer sections of the message.

Ranging uses standard radar practice, familiar to one skilled in the art. Two general approaches, provided for illustration and without limitation, which are appropriate to this problem are: (1) coded wide-band pulse) and (2) direct sequence encoded PSK or similar modulation. Within the relevant bandwidth constraints, the coded pulse train may be more immune to dense multipath, and hence is the preferred embodiment.

The coded wide-band pulse train is a sequence of pulses. The interval between the pulses is pseudo-randomly generated. The receiver sees the first pulse to arrive and then looks for the other pulses for confirmation at expected times. A range gate is employed to eliminate reflected versions of the pulse train arriving later due to multipath. Each pulse is received as a signal with a rise time which depends upon the band-width of the signal and the receiver. Another method, used in GPS, encodes the radar pulse with a binary phase coded pseudo-noise (PN) signal. There is almost no difference between this encoding and that done in modem direct-sequence, spread-spectrum communication system. Generally, the radar code is shorter, as there is no attempt at covertness. Chip generation, modulation, and demodulation of the PN code are handled in the same manner as a typical 802.11b DS link. An I-Q detector yields transitions in phase of the signal over time, which are then averaged over the sample in a manner similar to that used in the pulse system. In either case, the fundamental constraints of bandwidth upon resolution apply.

The data Signal structure must be spectrally efficient to deliver the high data rate required, and must have superior immunity to multipath. As pointed out in the Background of the invention, COFDM and MIMO methods can achieve these goals.

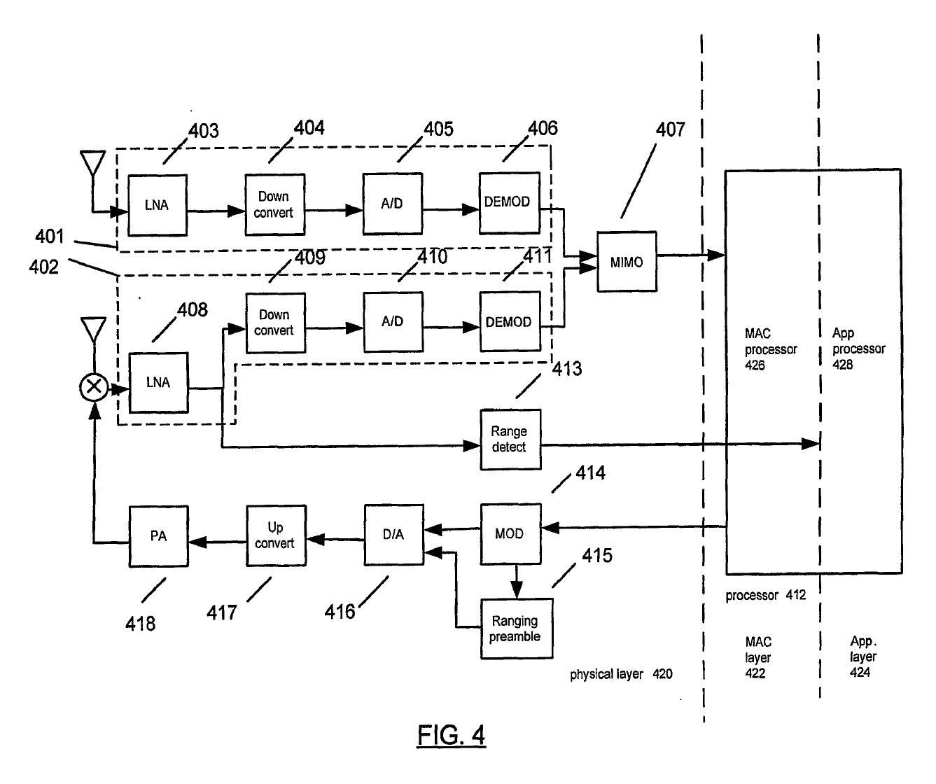

A transceiver logical block diagram is shown in FIG. 4.

This is a standard radio architecture, with the addition of the range processing signal blocks. This architecture is described below in terms of functional blocks.

There are one or more receiver chains (two are shown on the drawing, (401) and (402)) to provide spatial diversity in reception. Each of them includes the following elements:

1. Low noise amplifier/broadband RF front end (403,408)

2. down-converter to a frequency lower than 5.9 GHz which is economic for direct conversion (404,409)

3. conversion to digital (405,410)

4. a COFDM demodulator, following conventional practice as embodied in 802.16 and 802.11n (406,411)

5. MIMO decode and combination (407)

These receivers provide a data stream to the processor (412), which operates as described in more detail below.

At least one of the RF front ends also feed a range detection processor (413), which decodes the time-of arrival vs. time-of transmission, and executes the position location function in a manner analogous to state-of-the-art GPS receivers. The best estimate of position is also fed to the MAC processor (425).

The COFDM modulator (414) receives message frames from the MAC processor (425), initiates a ranging preamble from the preamble generator (415), modulates the data according to conventional COFDM practice, and sends the result to the Digital/analog conversion block (416) which feeds an up-converter (417) power amplifier (418), and antenna (419), following conventional design practice.

The transmit chain may also be duplicated one or more times in a MIMO configuration.

The transceiver architecture shown in FIG. 4 can also be described in terms of layers of a protocol stack. The left-hand portion of FIG. 4 comprises the physical layer (420), the central portion the Media Access control (or MAC) layer (422), and the right-hand portion the Application layer, relevant portions of which are described in more detail below. It will be obvious to one skilled in the art that the specific functional blocks within the protocol layers may be variously embodied as analog circuits, arrays of digital gates, programmable gate arrays, and sequential processors.

The Autonomous MAC Structure

The design requires an efficient MAC for a frequency positioning and safety channel which offers low guaranteed latency in emergencies and decentralized control and does not require stationary subnets, with their associated hand-off problems.

The chosen algorithm operates as follows:
1. Subscribers can be thought of as belonging to “cells”.
2. Each subscriber transmits (within its TDMA time slot) a vector with N entries (otherwise known as Frame Information or FI 114) specifying the status (busy or free slot as determined by whether a broadcast in the slot was heard by the subscriber) of each of the preceding N time slots (308 of FIG. 3).
3. New subscribers (listening to the vectors FI 114 transmitted by the established subscribers within range around them) take a slot which is open in all of the FIvectors 114 and join in.

Basic Rules for slot occupancy are the following:
1. If two subscribers entering a cell choose the same slot, a garbled message is heard in the slot and the the established subscribers respond to the garbled message by setting their FIs 114 to indicate that the requested slot is still free.
2. The next time the entering subscribers listen to an established subscriber they. will see from the established subscriber's FI 104 that the slot they had chosen has not been assigned to them and therefore will try to pick another slot.
3. Cells re-use slots occupied in other cells that are out of range.

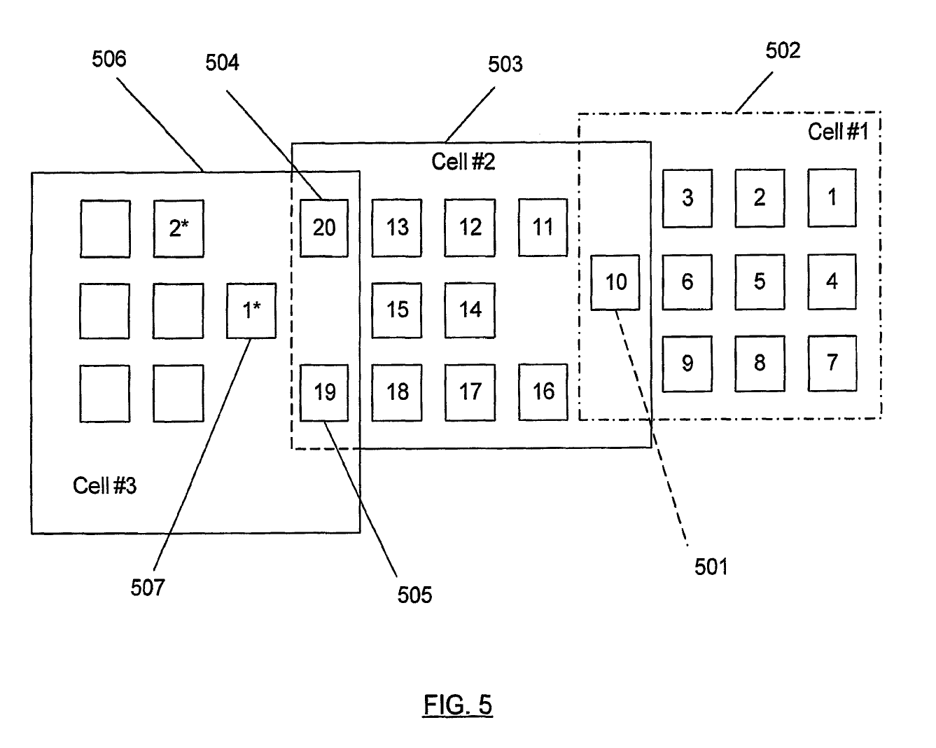

To further explain this process, FIG. 5 illustrates a typical coverage situation. Each small rectangle denotes a subscriber and each larger rectangle a cell coverage area. The numbers in the smaller, “subscriber” rectangles denote the slot number in which they transmit.

Subscriber (501) assigned slot 10 hears the subscribers assigned slots 1-20, comprising coverage area (502) and coverage area (503)

Subscribers (504) and (505) assigned slots 19-20 hear slots 10-18. In coverage area # 3 (506), Subscriber (507) marked 1* can be reassigned slot 1.

If subscriber 1* (507) (that was assigned slot 1) moves ahead to join coverage area #1 (502) it will listen to the channel assignments and be reassigned to an open channel.

For illustration consider a system whose basic timing is that shown in FIG. 2, This requires 135 microseconds per slot including guard time. There are 200 slots per recurring cycle. The cycle duration is 0.027 seconds. The transmit power is set such that the range is 300 feet, creating a cell diameter of 300 feet. In a worst case scenario where highway speed is 65 MPH, there is a subscriber every 50 feet in each of four lanes, So there are 12 subscribers per lane multiplied by 8 lanes equaling 96 subscribers, or 100 slots occupied at any one time.

Simulation shows that for the above 200/100 situation a new subscriber requesting a slot will be assigned one in no more then 5 cycles, or 5×0.27=0.14 seconds.

Mesh Networking

There is an obvious benefit in notifying vehicles approaching an accident or other emergency situation, if they can receive a warning beyond the range of one cell. This can be accomplished by forwarding emergency information in the status field to adjacent cells which are moving toward the location of the emergency. The selection of information to be so forwarded is embodied in the application layer of the system (424).

FIG. 3 shows one preferred packet format in detail. This packet includes a vehicle status data structure (309), which in turn contains multiple fields as shown in the figure. In one embodiment, 4 bytes are used for a unique vehicle identifier (311). 1 byte (312) is allocated to the vehicle traffic situation, indicating such facts as recent variations in vehicle speed (as occur in congested highway traffic), whether the vehicle has been stopped within the last minute, and similar parameters. One byte (313) called chassis status is allocated to details of the transmitting vehicle Bits indicate facts including vehicle moving normally vs. stopped in gear vs. stopped in park/neutral. ABS currently engaged, stability control currently engaged, engine stalled, airbags deployed, hazard flashers on. A third byte (314) labeled chassis history indicates if these conditions have been present in the last minute.

There is a second section of the data field which is used to relay information received from vehicles ahead. In one embodiment, it contains one byte (315) stating a relay count (how many times this information has been relayed), 2 bytes of x and 2 bytes of y position 316) of the originating vehicle, and two bytes (317, 318) of originating vehicle's chassis status and chassis history. In this embodiment, 4 bytes are spare (319).

In the event that a vehicle receives a packet from a vehicle toward which it is currently traveling (as determined by the receiving vehicle's velocity vector and ±90 degrees and by the reported position of the transmitting vehicle), then the receiving vehicle will check the relay count field (315), If the content of this field is non-zero, the receiving unit will transmit the received vehicle information as part of its next regular status report, with the relay count number decremented by one. The relay count is initially set to a number chosen to control how far the data will propagate. If multiple reports qualifying to be relayed are received within a single time slot cycle, the unit will transmit the nearest or the most serious report first, according to an established set of priority rules embodied in a table within its software. For example, the highest priority might include a report of airbag deployment, indicating that a crash has occurred, while invocation of anti-lock breaking might be a medium priority and repeated sudden stops without ABS might be lower still.

The result of this is that information about a traffic emergency ahead will travel backward (opposite to the direction of vehicle travel) along the queue of approaching vehicles, at the rate of one cell per TDMA cycle, or, with the embodiment described, at the rate of about 37 cells per second. This will give approaching vehicles time to slow down or take other appropriate precautions. This selective transfer of information is of significant safety value, in that subscribers possessing knowledge of conditions in their vicinity can transfer that knowledge to other subscribers who need to know it, even though the transmitters do not know which subscribers need to know, and the subscribers who need to know do not know whom to ask.

Conclusion

The foregoing Detailed Description discloses to those skilled in the relevant technologies how to make and use the inventors' integrated vehicular positioning and communications system and has further disclosed the best mode presently known to the inventors of making and using the system. It will be immediately clear to those skilled in the relevant technologies that vehicular positioning and communications systems that work according to the principles disclosed herein may have many different implementations. For example, what is required to compute the ranging is knowing when a packet containing position information was received. In the preferred embodiment, a special full-spectrum ranging signal is employed for that purpose; in other embodiments, no special signal maybe required. Further, different frequencies, bandwidth per channel, time slot size and detailed slot structure may be employed to meet the requirements of specific applications. Similarly, the contents of the packets may vary with the application, as well as the ways in which the information in the packets is represented. The techniques employed in the mesh communications system may be used not only to pass data upstream from a vehicle, but also downstream. Finally the specific choice of parameters chosen in the description is intended for illustration only, and does not limit the generality of the inventions disclosed. For all of the foregoing reasons, the Detailed Description is to be regarded as being in all respects exemplary and not restrictive, and the breadth of the invention disclosed herein is to be determined not from the Detailed Description, but rather from the claims as interpreted with the fill breadth permitted by the patent laws.

1. Apparatus in a vehicle for determining the vehicle's position relative to a plurality of other vehicles, each of the vehicles of the plurality being associated with a set of time slots in a sequence of the time slots and
the apparatus comprising:
a physical layer;
a media access layer; and
an application layer,
the physical layer broadcasting packets in the set of time slots associated with the vehicle and receiving packets in the sets of time slots associated with the other vehicles;
the media access layer autonomously establishing the association between the vehicle and the set of time slots and providing packets received from the application layer to the physical layer and packets received from the physical layer to the application layer; and
the application layer providing a packet containing current position information for the vehicle to the media access layer for broadcast in a time slot of the set and computing the current position in the provided packet from a plurality of packets received from the other vehicles, the current position being computed using the time the packet was broadcast, the time the packet was received, and the position information in each of the plurality of received packets.

2. A method of allocating a band of spectrum between ranging and data transfer, the band being divided into time slots and the method comprising the steps performed in each time slot of:
transmitting a ranging preamble that occupies the band's entire bandwidth during a first portion of the time slot; and
transmitting one or more data packets during a second portion of the time slot, each packet being transmitted on a discrete sub-band of the band of spectrum.

3. The method set forth in claim 2 wherein:
the packet that is transmitted on at least one of the discrete sub-bands is transmitted according to a IDMA MAC protocol which is self-organizing and deterministic.

4. The method set forth in claim 3 wherein:
the packet that is transmitted on another one of the discrete sub-bands is transmitted according to a non-deterministic MAC protocol.

5. Apparatus in a vehicle for relaying information about another vehicle to a plurality of the other vehicles, each of the vehicles being associated with a set of time slots in a sequence of the time slots and
the apparatus comprising:
a physical layer;
a media access layer; and
an application layer,
the physical layer broadcasting packets received from the media access layer in the time slots associated with the vehicle and receiving packets in the time slots associated with the other vehicles and providing the received packets to the media access layer, the packets including first position and status information for the vehicle associated with the time slot the packet is broadcast in and second position and status information for a vehicle of the plurality of other vehicles,
the media access layer providing packets received from the application layer to the physical layer and providing packets received from the physical layer to the application layer, and
the application layer selecting information to be included in the second position and status information in the next packet to be provided to the media access layer from the first or second position and status information in the packets received from the media access layer.
